(19) United States
(12) Patent Application Publication
(10) Pub. No.: US 2012/0085027 A1
(43) Pub. Date: Apr. 12, 2012

(54) PRESSURE WAVE PULVERIZER FOR GASIFICATIN APPLICATIONS

(75) Inventors: Steven Craig Russell, Houston, TX (US); Aaron Avagliano, Houston, TX (US)

(73) Assignee: General Electric Company, Schenectady, NY (US)

(21) Appl. No.: 12/899,892

(22) Filed: Oct. 7, 2010

(51) Int. Cl. C10J 3/68; B02C 23/00; B02C 19/06

(52) U.S. Cl. 48/77; 48/62 R; 48/197 R; 241/39; 241/65; 241/48

(57) ABSTRACT

A gasification apparatus includes a pressure wave pulverizer and a gasifier. The pressure wave pulverizer includes a first gas flow generator and a passage with a pulverizer inlet, a pulverizer outlet, and a gas inlet. The pulverizer inlet is supplied with the solid feedstock. The passage includes a gas acceleration section. The gas flow generator is configured to draw high speed gas through the gas inlet so as to induce pressure waves in the gas acceleration section thereby drying the solid feedstock and disintegrating the solid feedstock into particles. The gasifier is in flow communication with the pulverizer outlet.

### BACKGROUND OF THE INVENTION

1. Field of the Invention

The present invention relates to apparatus and methods for drying solid feedstock for gasification applications and, more particularly, drying such solid feedstock using a pressure wave pulverizer or the combination of a pressure wave pulverizer and a fluidized bed dryer.

The gasification of solid feedstock and subsequent combustion of hydrocarbon components from the feedstock in a gas turbine engine are known. In the case of coal used as the feedstock, most gasification processes require relatively dry (low moisture content) coal because of the difficulties in conveying moist solids and the inherent efficiency losses associated with moisture present in the coal feedstock. Since almost all commercially available coals contain a certain amount of water, the need exists to dry the coal in an efficient manner prior to gasification.

While certain methods of drying solid feedstock are known in the art, these methods may involve undesirable characteristics, such as inefficiencies or emission of pollutants. Therefore, there is a need for alternative ways of drying solid feedstock for gasification applications.

2. Brief Description of the Invention

The following presents a simplified summary of the invention in order to provide a basic understanding of some example aspects of the invention. This summary is not an extensive overview of the invention. Moreover, this summary is not intended to identify critical elements of the invention nor delineate the scope of the invention. The sole purpose of the summary is to present some concepts of the invention in simplified form as a prelude to the more detailed description that is presented later.

In accordance with one aspect, a gasification apparatus includes a pressure wave pulverizer and a gasifier. The pressure wave pulverizer includes a first gas flow generator and a passage with a pulverizer inlet, a pulverizer outlet, and a gas inlet. The pulverizer inlet is supplied with the solid feedstock. The passage includes a gas acceleration section. The gas flow generator is configured to draw high speed gas through the gas inlet so as to induce pressure waves in the gas acceleration section thereby drying the solid feedstock and disintegrating the solid feedstock into particles. The pressure waves, which may include shock waves, contain high energy that is applied to the particles. The gasifier is in flow communication with the pulverizer outlet.

In accordance with another aspect, an integrated system for pulverizing and drying solid feedstock for a gasification application includes a pressure wave pulverizer and a fluidized bed dryer. The pressure wave pulverizer includes a first gas flow generator and a passage with a pulverizer inlet, pulverizer outlet, and a gas inlet. The pulverizer inlet is supplied with the solid feedstock. The passage includes a gas acceleration section. The gas flow generator is configured to draw high speed gas through the gas inlet so as to induce pressure waves in the gas acceleration section, which may include shock waves, thereby drying the solid feedstock and disintegrating the solid feedstock into particles. The fluidized bed dryer is in flow communication with the pressure wave pulverizer and includes a chamber, a bed inlet, a bed outlet, a process gas inlet, a process gas outlet, heating coils housed within the chamber and a second gas flow generator. The second gas flow generator is configured to generate movement of a process gas. The chamber is configured to channel the solid feedstock along a predetermined path from the bed inlet to the bed outlet. The chamber is configured to channel the process gas along a process gas path from the process gas inlet to the process gas outlet. The predetermined path is disposed to pass across the heating coils in heat exchange relationship with the feedstock. The process gas path is disposed in a cross-flow relationship with respect to the predetermined path.

A method of drying solid feedstock for a gasification apparatus, includes the steps of generating high speed gas flow in a passage including a gas acceleration section, introducing the solid feedstock into the gas acceleration section to dry the solid feedstock and disintegrate the solid feedstock into particles, and channeling the feedstock to a gasifier.

### BRIEF DESCRIPTION OF THE DRAWING

The foregoing and other aspects of the present invention will become apparent to those skilled in the art to which the present invention relates upon reading the following description with reference to the accompanying drawings, in which:

FIG. 1 is a schematic view of a first example embodiment of an integrated system including a pressure wave pulverizer and a fluidized bed dryer in flow communication with a gasifier;

FIG. 2 is a schematic view of a second example embodiment of the integrated system including a pressure wave pulverizer and a fluidized bed dryer in flow communication with a gasifier;

FIG. 3 is a schematic view of a third example embodiment of the integrated system including a plurality of pressure wave pulverizers in flow communication with a gasifier with the pressure wave pulverizers being connected serially;

FIG. 4 is a schematic view of a fourth example embodiment of the integrated system including a plurality of pressure wave pulverizers in flow communication with a gasifier with the pressure wave pulverizers being connected parallelly;

FIG. 5 is a detailed schematic view of the first example embodiment of the integrated system;

FIG. 6 is a detailed schematic view of the pressure wave pulverizer;

FIG. 7 is a detailed schematic view of an alternative embodiment of the pressure wave pulverizer; and

FIG. 8 is a detailed schematic view of the pressure wave pulverizer in flow communication with the gasifier;

FIGS. 9-11 shows three schematic views of the pressure wave pulverizer and the fluidized bed dryer in flow communication with the gasifier.

### DETAILED DESCRIPTION OF THE INVENTION

Examples of embodiments that incorporate one or more aspects of the present invention are described and illustrated in the drawings. These illustrated examples are not intended to be a limitation on the present invention. For example, one or more aspects of the present invention can be utilized in other embodiments and even other types of devices.

The present disclosure relates to gasification applications which involve converting carbonaceous materials, such as coal, petroleum, biofuel, or biomass, into carbon monoxide and hydrogen by reacting raw material at high temperatures with a controlled amount of oxygen and/or steam. The resulting gas mixture is a type of fuel called synthetic gas or syngas which may include varying amounts of carbon monoxide, methane, and hydrogen. Carbonaceous substance refers to a substance consisting of, containing or capable of yielding carbon.

An exemplary integrated gasification combined-cycle (IGCC) system may include a main air compressor, an air separation unit coupled in flow communication to compressor, a gasifier coupled in flow communication to air separation unit, a gas turbine engine coupled in flow communication to gasifier, and a steam turbine. In operation, compressor compresses ambient air that is then channeled to air separation unit. In some embodiments, in addition to or in the alternative to compressor, compressed air from gas turbine engine compressor is supplied to air separation unit. Air separation unit uses the compressed air to generate oxygen for use by gasifier. More specifically, air separation unit separates the compressed air into separate flows of oxygen and a gas by-product, sometimes referred to as a “process gas”. The process gas generated by air separation unit includes nitrogen and is referred to herein as “nitrogen process gas”. The nitrogen process gas may also include other gases such as, but not limited to, oxygen and/or argon. For example, in some embodiments, the nitrogen process gas includes between about 95% and about 100% nitrogen.

The oxygen flow from air separation unit is channeled to gasifier for use in generating partially combusted gases, referred to herein as “syngas” for use by gas turbine engine as fuel, as is described in more detail herein. In some embodiments, at least some of the nitrogen process gas flow, a by-product of air separation unit, is vented to the atmosphere. Moreover, in other embodiments, some of the nitrogen process gas flow is injected into a combustion zone within gas turbine engine combustor to facilitate controlling emissions generated within engine, and more specifically to facilitate reducing the combustion temperature and nitrous oxide emissions from engine. In the exemplary embodiment, IGCC system also includes a compressor for compressing the nitrogen process gas flow before it is injected into the combustion zone.

Gasifier converts a mixture of fuel, the oxygen supplied by air separation unit, and recycle solids, and/or liquid water and/or steam, and/or a slag additive into an output of syngas for use by gas turbine engine as fuel. Although gasifier may use any fuel, in some embodiments, gasifier uses coal, petroleum coke, residual oil, oil emulsions, tar sands, and/or other similar fuels. In the exemplary embodiment, the syngas generated by gasifier includes carbon dioxide. As such, in the exemplary embodiment, the syngas generated by gasifier is cleaned in a clean-up device before being channeled to gas turbine engine combustor for combustion thereof. Carbon dioxide may be separated from the syngas during clean-up and, in the exemplary embodiment, the carbon dioxide is vented to the atmosphere. In the exemplary embodiment, a gasifier blowdown connection is coupled to a waste treatment system.

Power output from gas turbine engine is used to drive a generator that supplies electrical power to a power grid. Exhaust gases from gas turbine engine are supplied to a heat recovery steam generator that generates steam for use by steam turbine. Power generated by steam turbine drives an electrical generator that supplies electrical power to a power grid. In the exemplary embodiment, steam from heat recovery steam generator is supplied to gasifier for generating the syngas.

In the exemplary embodiment, IGCC system includes a syngas condensate stripper that receives condensate from a stream of syngas discharged from gasifier. The condensate typically includes a quantity of ammonia that is dissolved in the condensate. At least a portion of the dissolved ammonia is formed in gasifier from a combination of nitrogen gas and hydrogen in gasifier. To remove the dissolved ammonia from the condensate the condensate is boiled. Stripped ammonia is discharged from stripper and is channeled to a waste treatment system. In an alternative embodiment, the stripped ammonia is returned to gasifier, at a pressure that is higher than that of the gasifier, to be decomposed in a high temperature region of the gasifier proximate a nozzle tip. The ammonia is injected into the gasifier such that the flow of ammonia in the vicinity of the high temperature region proximate nozzle tip facilitates cooling nozzle tip.

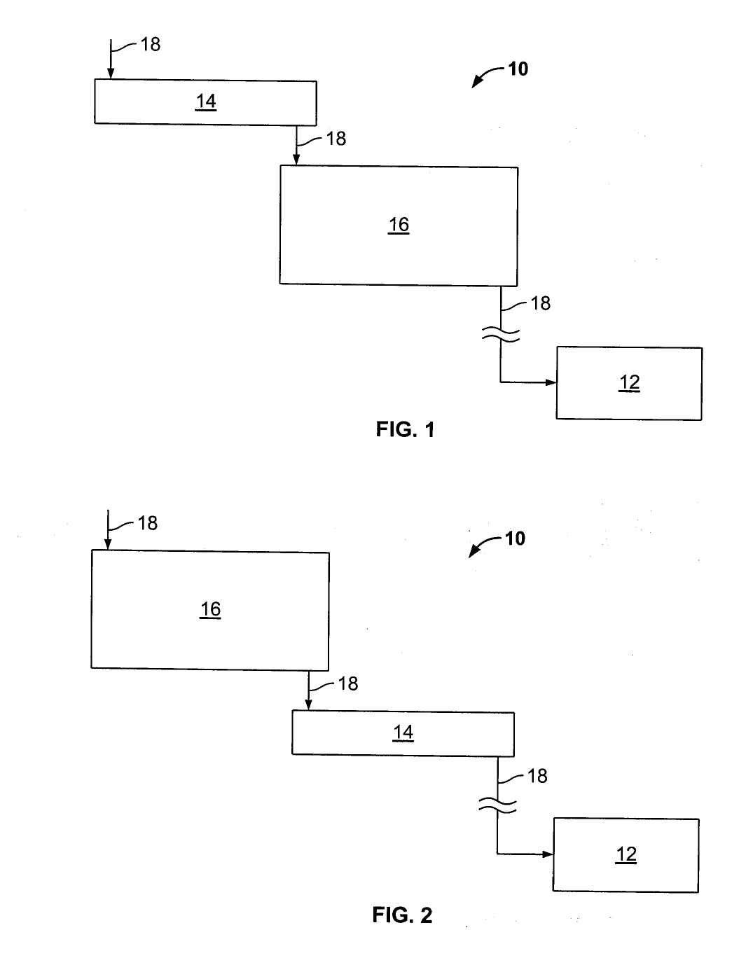

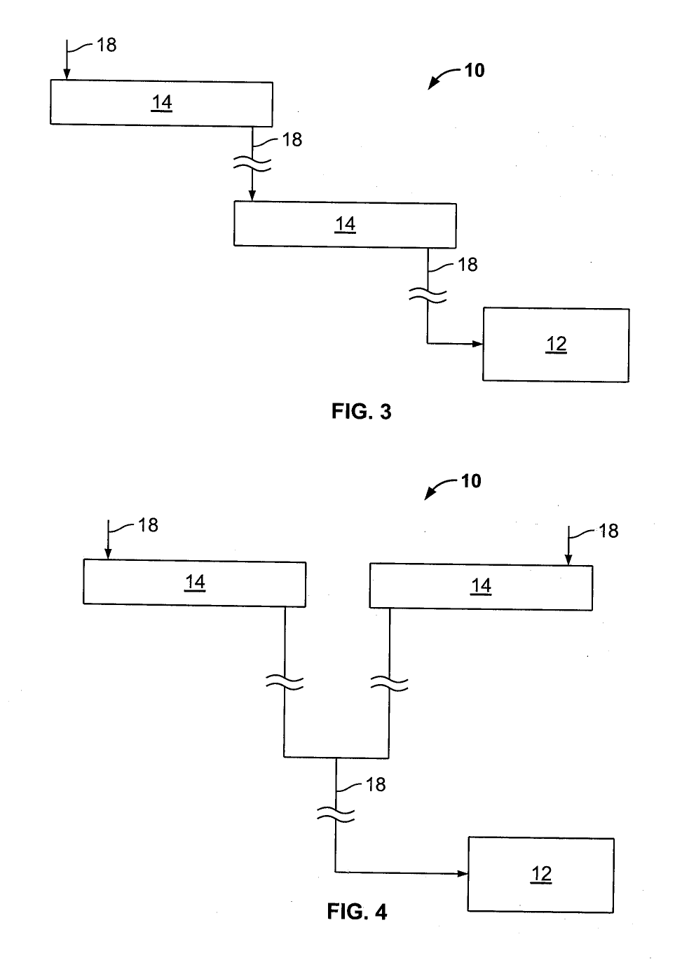

FIGS. 1 and 2 illustrate simplified schematics of example embodiments of systems 10 configured to dry and/or pulverize solid feedstock 18. Each of the systems is in flow communication with a gasifier 12 and may include at least one of two main parts: a pressure wave pulverizer 14 and a fluidized bed dryer 16. The function of the pressure wave pulverizer 14 is to pulverize and dry the solid feedstock 18 while the fluidized bed dryer 16 provides additional drying of the solid feedstock 18. In an integrated system 10 that includes both of the main parts, as shown in FIG. 1, the solid feedstock 18 move through the pressure wave pulverizer 14 first and then downstream to the fluidized bed dryer 16. However, the order of the two main parts can vary and, alternatively, as shown in FIG. 2, the solid feedstock 18 can move through the fluidized bed dryer 16 first and then downstream to the pressure wave pulverizer 14. However, it must be noted that the fluidized bed dryer 16 need not be part of the system 10. FIGS. 3 and 4 are variations of FIG. 1 with a plurality of the pressure wave pulverizers 14 arranged serially and parallelly respectively. A variety of devices, including the fluidized bed dryer 16, may be downstream or upstream of a pressure wave pulverizer 14 and are omitted from FIGS. 3 and 4.

Of interest for typical gasification applications of the pressure wave pulverizer 14 is the improved efficiency, availability, and cost compared to alternative size reduction and drying technologies. High overall plant efficiency is achieved because the pressure wave pulverizer does not require an external fuel source like fuel gas or steam to supply energy for drying. It simply uses electricity, which may be more readily available at a gasification plant. High availability is achieved because the pressure wave pulverizer system is mechanically simple and easy to operate. Equipment inspection and maintenance is also simple because the pressure wave pulverizer is of compact size and has few wear components. Further, the equipment has a very short start-up and shutdown time allowing for fast response to changing plant conditions. Additionally, small footprint and readily available parts result in a low capital cost of the pressure wave pulverizer system.

However, a drawback in the pressure wave pulverizer 14 itself may be limited operational flexibility and controllability in terms of solids product grind size and moisture content. There are relatively few parameters on the machine to adjust during on-line operation to adjust the product characteristics. Further, since the residence time in the machine is low, variations in the product characteristics over time are not easily corrected. Also, the product characteristic may be influenced by ambient conditions such as cold weather, high humidity, rain or snow. Therefore, a highly tunable fluidized bed dryer may also be utilized to precisely control the product moisture content. The fluidized bed dryer is a long residence time device with several on-line adjustable parameters to control product moisture content. A system with both the pressure wave pulverizer and the fluidized be dryer may be advantageous than a fluidized bed dryer alone. In this way, the drying duty is shared between the two equipments. If all of the drying was dependent upon the fluid bed dryer alone, the equipment would have a large footprint, high capital cost, and large energy requirement from a heat source such as steam. In conjunction, the system with both the pressure wave pulverizer and fluidized bed dryer devices will offer improved efficiency, availability, and cost with minimum variation in product characteristics.

The fluidized bed dryer is one example of various types of drying systems that can be used to dry the solid feedstock ground by the pressure wave pulverizer. Alternatively, the drying system can be a paddle dryer, a screw dryer, a drum dryer, a rotary pan dryer, a vibrating pan dryer, a radiant dryer, or any other bulk solids drying systems known in the art.

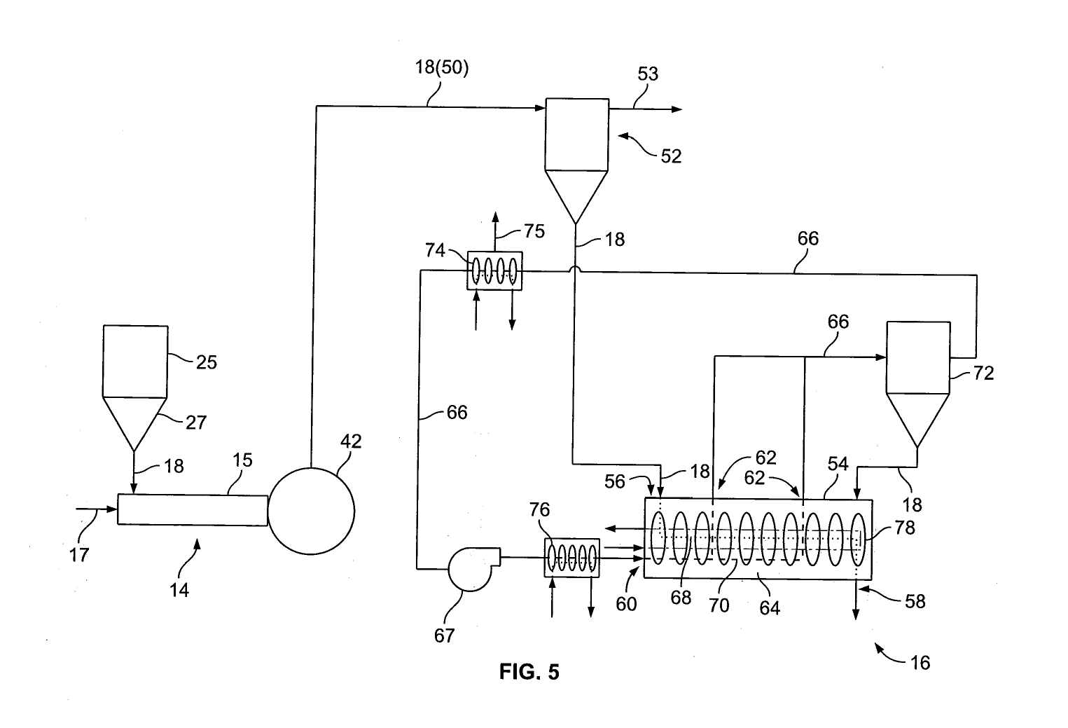

FIG. 5 shows a detailed schematic representation of the integrated system 10 of FIG. 1. It must be noted that the specific features shown in FIG. 5 would also be similarly illustrated in a detailed schematic representation of FIG. 2.

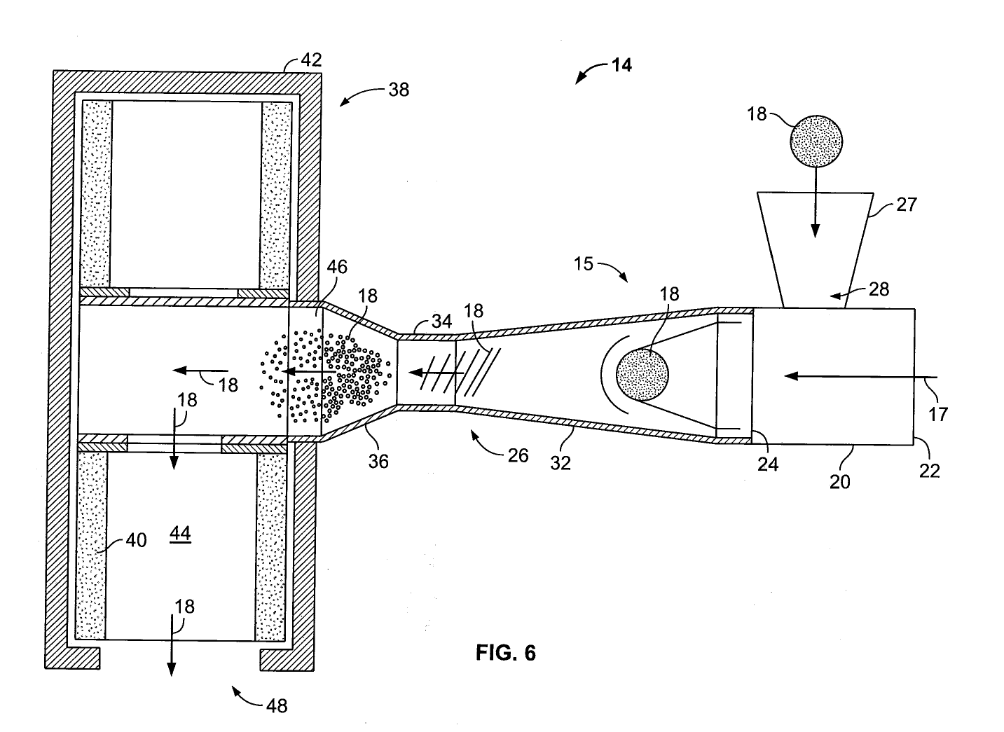

FIG. 6 shows an example embodiment of the pressure wave pulverizer 14 that is configured to pulverize and extract moisture from the solid feedstock 18 using high speed gas. The pressure wave pulverizer 14 includes a passage 15 that has an inlet tube 20 with a first end 22 communicating with ambient atmosphere, if air is used, and an opposing, second end 24 that is coupled to a gas acceleration section 26 which may be embodied as a venturi. The inlet tube 20 provides some distance to the gas acceleration section 26 in which the feedstock 18 can accelerate to the required velocity. The inlet tube 20 includes a pulverizer inlet 28 allowing communication with a hopper 30 that receives feedstock 18 from a feeding system 25 via a hopper 27. The gas acceleration section 26 includes a converging portion 32 coupled to the inlet tube 20 in this embodiment. The gas acceleration section 26 further includes a throat 34 that may maintain a consistent diameter that is smaller than a diameter of the inlet tube 20. The gas acceleration section 26 further includes a diverging portion 36 that couples to the throat 34 and may progressively increases in diameter in the direction of gas flow 17. The gas acceleration section 26 is in communication with a gas flow generator 38 that creates a gas flow flowing from the first end 22, through the inlet tube 20, through the gas acceleration section 26, and to the gas flow generator 38. The gas flow velocity may be greater in the tube of the gas acceleration section 26 than in the inlet tube 20. The gas flow generator 38 may be embodied as a fan, an impeller, a turbine, a hybrid of a turbine and fan, a pneumatic suction system or other suitable device for generating high speed gas flow. The gas flow generator 38 is driven by a motor that may be embodied in various forms.

The gas flow generator 38 includes a plurality of radially extending blades 40 that rotate to generate a high speed gas flow. The gas flow generator 38 is disposed within a housing 42 that includes a housing outlet that provides an exit to incoming gas. The housing 42 couples with the gas acceleration section 26 at a pulverizer outlet 46 and has a housing input aperture (not shown) that allows communication between the gas acceleration section 26 and the interior of the housing 42. The blades 40 define radially extending flow passages 44 through which gas passes to a housing outlet 48 on its periphery to allow pulverized feedstock 18 to exit.

In operation, feedstock 18 is introduced into the inlet tube 20 through any number of conveyance methods. While it is contemplated that the feedstock 18 will be solid, the pressure wave pulverizer 14 may be used to dry and pulverize semi-solid material as well. The gas flow generator 38 generates a gas stream, ranging from 350 mph to supersonic, that flows through the inlet tube 20 and through the gas acceleration section 26. In the gas acceleration section 26, the gas flow velocity substantially accelerates and the feedstock 18 is propelled by the high speed gas flow to the gas acceleration section 26. The feedstock 18 is smaller in diameter than the interior diameter of the inlet tube 20 and a gap exists between the inner surface of the inlet tube 20 and the feedstock 18.

In this embodiment, as feedstock 18 enters the converging portion 32, the gap becomes narrower and eventually the feedstock material causes a substantial reduction in the area of the converging portion 32 through which gas can flow. A recompression shock wave trails rearwardly from the feedstock material and a bow shock wave builds up ahead of the feedstock material. Where the converging portion 32 merges with the throat 34, there is a standing shock wave. The action of these shock waves impacts the feedstock 18 and results in pulverization and moisture extraction from the feedstock 18. The pulverized feedstock 18 continues through the gas acceleration section 26 and exits into the gas flow generator 38.

The gas acceleration section 26 provides a point of impact between higher velocity shock waves and lower velocity shock waves. The pressure waves provide a pulverization and moisture extraction event within the gas acceleration section 26. In operation, there are no visible signs of moisture on the interior of the gas acceleration section 26 or in the housing outlet 48. The amount of moisture removed is substantial although a residual amount may remain.

The feedstock material size reduction depends on the feedstock material to be pulverized, the dimensions of the pressure wave pulverizer 14, and the machine operation settings. For example, by increasing the velocity of the gas flow, pulverization and particle size reduction increase with certain materials. Thus, the pressure wave pulverizer 14 allows the user to vary desired particle dimensions by varying the velocity of the gas flow.

The feedstock material, moisture and gas stream proceed through the gas flow generator 38 and exit through the housing outlet. The housing outlet 48 is coupled to an exhaust pipe 50 which delivers that feedstock material to a particulate collector 52 such as a cyclone for feedstock material 18 and gas 53 separation. The diameter of the exhaust pipe 50 impacts the amount of drying that further occurs. High gas volume is required for further drying of feedstock material. In the exhaust pipe 50, the faster moving gas in the exhaust pipe 50 passes the feedstock 18 and removes moisture remaining on the feedstock material. The gas and vapor travel to the particulate collector 52 where gas and vapor are separated from the solid feedstock.

A pulverization event may generate heat that assists in drying the feedstock material. In addition to pulverization, rotation of the gas flow generator 38 may generate heat. The dimensions between the housing 42 and the gas flow generator 38 could be such that during rotation the friction generates heat. The heat may exit through the housing outlet 48 and exhaust pipe 50 and further dehydrates the feedstock as the feedstock travels to the particulate collector 52.

The diameter of the housing outlet 48 may be increased or decreased to adjust the resistance and the amount of heat traveling through the housing outlet 48 and exhaust pipe 50. The diameter of the exhaust pipe 50 and the housing outlet 48 affects the removal of moisture on pulverized feedstock material. The pulverization and moisture extraction increases as the gas flow generated by the gas flow generator 38 increases. If gas flow is increased or decreased, the diameter of the exhaust pipe 50 and the housing outlet 48 may be decreased to provide the same feedstock material dehydration.

Heavier materials with less water, such as rocks, require less moisture extraction. With such materials, diameters of the housing outlet 48 and exhaust pipe 50 may be increased as less drying is required. Consequently, with wetter materials, the diameters of the housing outlet 48 and the exhaust pipe 50 may be decreased to increase the amount of gas and heat to achieve the proper dehydration of the feedstock 18.

The angle of inclination of the exhaust pipe 50 relative to the longitudinal axis of the gas acceleration section 26 and gas flow generator 38 also may affect dehydration performance. Material traveling upward is held back by gravity whereas gas is less restricted by gravity. This allows the gas to move faster than the feedstock material and may increase moisture removal.

The particulate collector 52, such as a cyclone, is an apparatus for separating particles from a gas flow. The cyclone 52 typically includes a setting chamber in the form of a vertical cylinder. Cyclones 52 can be embodied with a tangential inlet, axial inlet, peripheral discharge or an axial discharge. The gas flow and particles enter the cylinder through an inlet and spin in a vortex as the gas flow proceeds down the cylinder. A cone section causes the vortex diameter to decrease until the gas reverses on itself and spins up the center to an outlet. Particles are centrifuged toward the interior wall and collected by inertial impingement.

Other aspects of the pressure wave pulverizer 14 are described in U.S. Patent Application Publication No. 2009/0214346 to Graham et al. Other embodiments of pressure wave pulverizers 14 can be used that do not contain the exact features of the one described herein or in the Graham reference. Other machines that rely on the same principles may use other methods to generate pressure waves or high-speed vortices that contain a large amount of kinetic energy. For instance, the machine may not include a venture section and may include other features such as a vortex stabilization body.

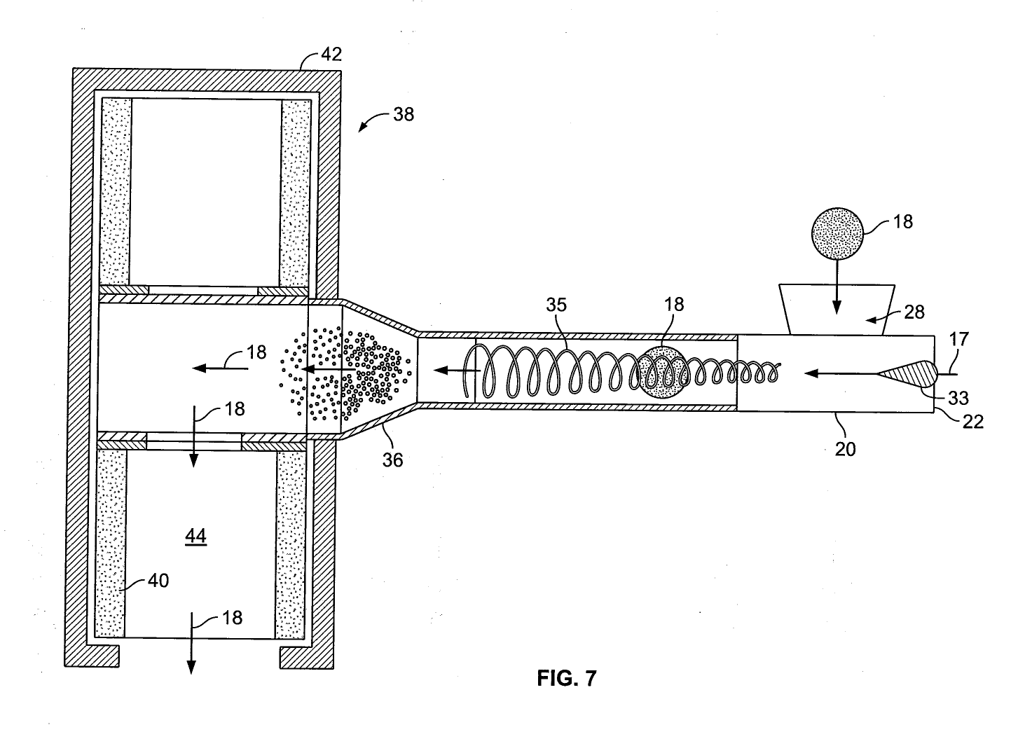

FIG. 7 shows an alternative embodiment of a pressure wave pulverizer that does not contain a venturi section upstream of the gas flow generator 38 and contains a vortex stabilization body 33. The vortex stabilization body 33 provides an attachment point for a gas vortex 35 being created by the high speed rotating gas flow generator 38.

Referring back to FIG. 5, an example embodiment of the fluidized bed dryer 16 is shown in a schematic manner. The bed dryer 16 includes a bed dryer housing 54 defining a chamber 64 in which the feedstock 18 to be dried moves through. The bed dryer housing 54 includes a bed inlet 56, a bed outlet 58, a process gas inlet 60 and a process gas outlet 62. The feedstock 18 is supplied through the bed inlet 56 that may be located on one end of the fluidized bed dryer 16 and exits through the bed outlet 58 that may be located on an opposite end of the fluidized bed dryer 16. In the embodiment of FIG. 5, the feedstock 18 has already been pulverized and possibly moderately dried at the pressure wave pulverizer 14 and arrives at the fluidized bed dryer 16 after having gone through the particulate collector 52 where the feedstock particulates are separated from gas. Since the feedstock 18 is in a pulverized particle state, it may be possible to move the feedstock particles through the chamber 64 by mixing the particles with a process gas 66 that is channeled from the bed inlet 56 to the bed outlet 58 by way of a gas flow generator 67 such as a blower. The process gas 66 is in a heated state and may be steam, nitrogen, carbon dioxide gas, a type of inert gas or the like. If the solids of feedstock 18 are larger than a particulate state, it may be difficult to generate movement of the feedstock 18 within the chamber 64 using process gas 66. In such a case, the movement of the larger solids of feedstock 18 may be generated alternatively by a variety of mechanisms, such as a vibratory motion, conveyer belt, an extruding screw, or the like.

The feedstock 18 follows a predetermined path 68 by which it moves through the chamber 64 and the process gas 66 follows a process gas path 70 through the chamber 64. The process gas path 70 is disposed to go across the predetermined path 68 thereby arranging the process gas path 70 and the predetermined path 68 in a cross-flow relationship in which the paths 68 and 70 intersect with one another. Such an arrangement allows heat exchange to occur between the process gas 66 and the feedstock 18 such that moisture may be extracted from the feedstock 18. While the embodiment in FIG. 5 shows a substantially orthogonal arrangement of the process gas path 70 and the predetermined path 68, this is not necessary and the process gas path 70 may form an acute angle with the direction of the predetermined path 68. In one example embodiment, the process gas inlet 60 is provided at a lower part of the bed dryer housing 54 while the process gas outlet 62 are provided at an upper part of the bed dryer housing 54 such that the warm process gas 66 can naturally rise and exit the bed dryer housing 54.

After the process gas 66 has provided heating to the feedstock 18 and has exited the bed dryer housing 54 through the process gas outlet 62, the process gas 66 may be re-processed such that it can provide heating to the feedstock 18 and thereafter re-circulated to the process gas inlet 60. While the present embodiment provides a recirculation system for the process gas 66, a fluidized bed dryer 16 can be contemplated in which the process gas 66 simply flows through without being recirculated.

During recirculation, the process gas 66 may be directed to a particulate collector that can remove any particles of the feedstock 18 from the process gas 66 that have exited the bed dryer housing 54 instead of being channeled to the bed outlet 58. In one embodiment, the particulate collector 72 may be a cyclone and may channel the particles of feedstock 18 separated from the process gas 66 to the bed outlet 58. Moreover, condensing coils 74 may be provided in the recirculation system in order to remove moisture 75 from the process gas 66 whose moisture content was increased in the chamber 64. Furthermore, the recirculation system may include heating coils 76 provided to reheat the process gas 66 which has cooled due to the heat exchange with the feedstock 18 inside the chamber 64. Also, because some of the process gas 66 may be lost while moving through a recirculation loop, it may be necessary to make up for such lost process gas 66 during recirculation.

For additional drying of the feedstock, a set of heating coils 78 may be disposed inside the chamber 64 along the predetermined path 68 between the bed inlet 56 and the bed outlet 58 to allow moisture to be extracted from the feedstock 18 as the feedstock 18 moves through the chamber 64. The heating coils 76 can undergo heat exchange directly with the feedstock 18. Thus, moisture can be extracted from the feedstock either by the heating coils 78 or the process gas 66.

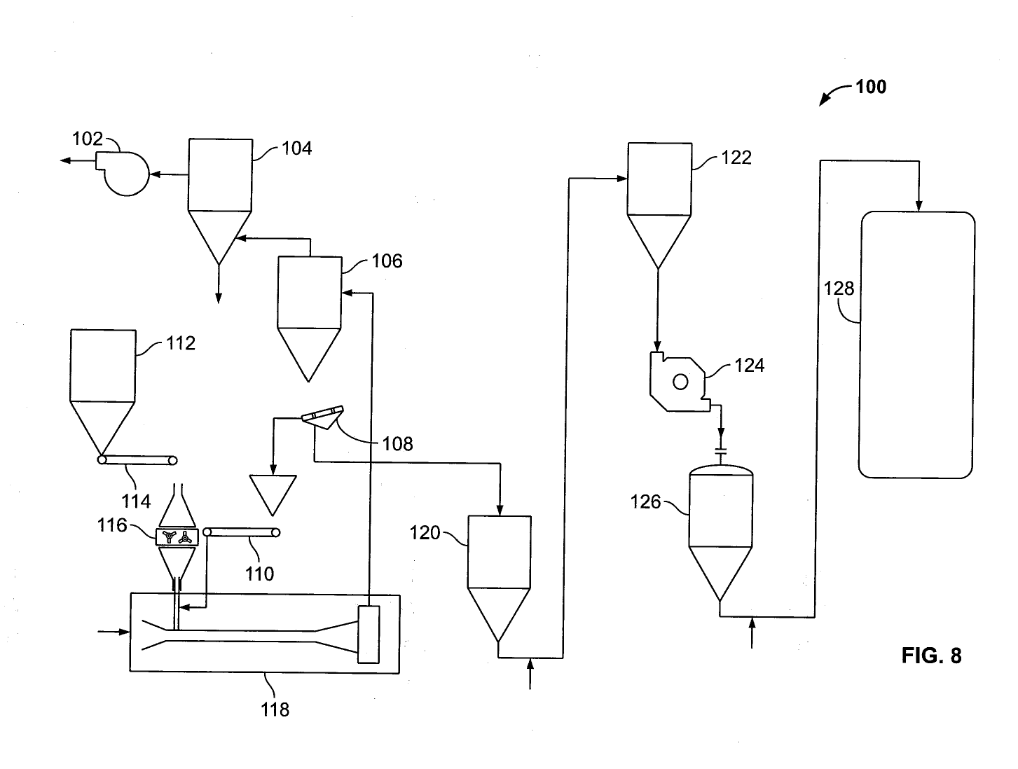

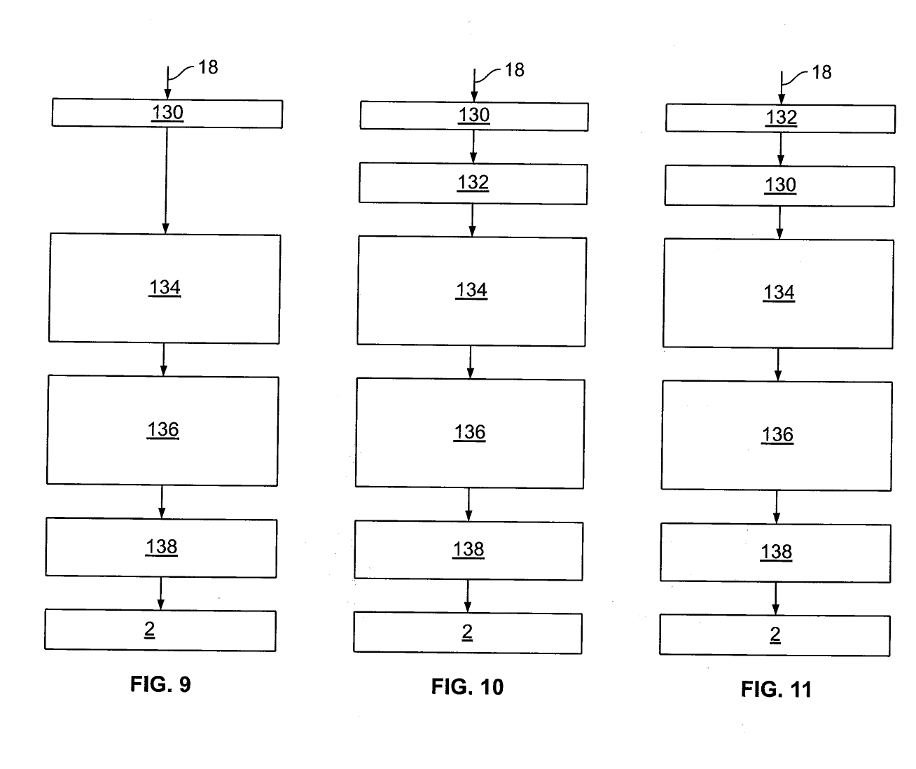

The pressure wave pulverizer 14 or combination of a pressure wave pulverizer 14 and fluidized bed dryer 16 are in flow communication with a gasifier 12. FIGS. 8 and 9 help explain the term “in flow communication” by illustrating examples of processes that the solids 18 undergo during movement between two or more of the pressure wave pulverizer 14, the fluidized bed dryer 16 and the gasifier 12.

FIG. 8 shows a specific embodiment of a particular feed system 100 including a fan 102, a baghouse 104, a cyclone 106, a screen 108, a first weigh belt feeder 110, a raw coal feed hopper 112, a second weight belt feeder 114, a hammer mill 116, a pressure wave pulverizer system 118, a pneumatic conveyance pick-up bin 120, a ground coal storage 122, a high pressure posimetric feeder 124, a conveyance vessel 126 and a gasifier 128. Raw coal from the feed hopper 112 is fed into the pressure wave pulverizer system 118 using the second weigh belt feeder 114. Solids are pulverized, dried, separated from the gas stream, and screened in the pressure wave pulverizer system 118. Oversize particles are returned to the inlet of the pulverizer system 118 downstream of the screen 108 by use of the first weigh belt feeder 110. Downstream of the pressure wave pulverizer system 118, the solids are stored in a hopper (e.g., the pneumatic conveyance pick-up bin 120) and vertically transported pneumatically to another storage hopper (e.g., the ground coal storage 122). Then, a feeding device, such as a bulk solids pump or the high pressure posimetric feeder 124, feeds the solids into a high pressure vessel (e.g. the conveyance vessel 126). The solids are then transported out of the high pressure vessel to the high pressure gasification chamber of the gasifier 128.

FIGS. 9-11 describes alternative systems in a more general manner. These diagrams show the pressure wave pulverizer 14 and combination of the pressure wave pulverizer 14 and fluidized bed dryer 16 in flow communication with a gasifier 12. The raw solids 18 are reduced to fine particles at the pulverizer 14 (step 130). The raw solids 18 may also be further dried at the fluidized bed dryer 16 (step 132) although the order of steps 130 and 132 are interchangeable, as illustrated by FIGS. 10 and 11. As a result, the solids 18 are brought to a ground, dry state (step 134). Thereafter, the solids 18 are transported to a high gas pressure environment by a solids feeding device (step 136), and then stored in a solids conveyance vessel or systems (step 138). The solids feeding device may consist of many mechanisms such as a lockhopper, rotary valve, or other types of solids feeding device. Many options exist for solids conveyance systems including mechanical and pneumatic systems. The gasifier 12 may operate at a range of pressure and may have any of a number of geometrical features. For instance, the gasifier 12 may have a single or multiple injection locations and the injection may occur at the top, bottom, or sides or a combination thereof.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

What is claimed is:

1. A gasification apparatus including:
a pressure wave pulverizer including a first gas flow generator and a passage with a pulverizer inlet, a pulverizer outlet, and a gas inlet, the pulverizer inlet supplied.with the solid feedstock, the passage including a gas acceleration section, the gas flow generator configured to draw high speed gas through the gas inlet so as to induce pressure waves in the gas acceleration section thereby drying the solid feedstock and disintegrating the solid feedstock into particles; and
a gasifier in flow communication with the pulverizer outlet.

2. The apparatus of claim 1, the pressure wave pulverizer further including a particulate collector, downstream of the pulverizer outlet, configured to separate the particles from gas.

3. The apparatus of claim 1, the gas acceleration section including a converging section, a throat, and a diverging section.

4. The apparatus of claim 1, the gas flow generator including a housing with a housing outlet and an impeller therein, the impeller including blades configured to eject the particles of feedstock radially outward to the pulverizer outlet.

5. The apparatus of claim 1, wherein the solid feedstock is coal.

6. The apparatus of claim 1, further including a drying system that is in flow communication with the pressure wave pulverizer so as to dry the solid feedstock.

7. The apparatus of claim 6, further including a fluidized bed dryer in flow communication with the pressure wave pulverizer and including a chamber, a bed inlet, a bed outlet, a process gas inlet, a process gas outlet, heating coils housed within the chamber and a second gas flow generator, the second gas flow generator configured to generate movement of a process gas, the chamber configured to channel the solid feedstock along a predetermined path from the bed inlet to the bed outlet, the chamber configured to channel the process gas along a process gas path from the process gas inlet to the process gas outlet, the predetermined path disposed to pass across the heating coils in heat exchange relationship with the feedstock, the process gas path disposed in a cross-flow relationship with respect to the predetermined path.

8. An integrated system for pulverizing and drying solid feedstock for a gasification application, including:
a pressure wave pulverizer including a first gas flow generator and a passage with a pulverizer inlet, pulverizer outlet, and a gas inlet, the pulverizer inlet supplied with the solid feedstock, the passage including a gas acceleration section, the gas flow generator configured to draw high speed gas through the gas inlet so as to induce pressure waves in the gas acceleration section thereby drying the solid feedstock and disintegrating the solid feedstock into particles; and
a fluidized bed dryer in flow communication with the pressure wave pulverizer and including a chamber, a bed inlet, a bed outlet, a process gas inlet, a process gas outlet, heating coils housed within the chamber and a second gas flow generator, the second gas flow generator configured to generate movement of a process gas, the chamber configured to channel the solid feedstock along a predetermined path from the bed inlet to the bed outlet, the chamber configured to channel the process gas along a process gas path from the process gas inlet to the process gas outlet, the predetermined path disposed to pass across the heating coils in heat exchange relationship with the feedstock, the process gas path disposed in a cross-flow relationship with respect to the predetermined path.

9. The system of claim 8, the pulverizer outlet located upstream of the bed inlet.

10. The system of claim 8, the bed outlet located upstream of the pulverizer inlet.

11. The system of claim 8, the fluidized bed dryer further including a recirculation system circulating the process gas from the process gas outlet to the process gas inlet.

12. The system of claim 11, the recirculation system including a first particulate collector configured to separate particles of feedstock from the process gas and channel the particles to the bed outlet.

13. The system of claim 11, the recirculation system including heating coils in heat exchange relationship with the process gas.

14. The system of claim 8, the pressure wave pulverizer further including a second particulate collector, downstream of the pulverizer outlet, configured to separate the particles from gas.

15. The system of claim 8; the gas acceleration section including a converging section, a throat, and a diverging section.

16. The system of claim 8, the first gas flow generator including a housing with a housing outlet and an impeller therein, the impeller including blades configured to eject the particles of feedstock radially outward to the pulverizer outlet.

17. The system of claim 8, wherein a plurality of pressure wave pulverizers are arranged serially or parallelly.

18. The system of claim 8, wherein the solid feedstock is coal.

19. A method of drying solid feedstock for a gasification apparatus, including, the steps of:
generating high speed gas flow in a passage including a gas acceleration section;
introducing the solid feedstock into the gas acceleration section to dry, the solid feedstock and disintegrate the solid feedstock into particles; and
channeling the feedstock to a gasifier.

20. The method of claim 19, further including the step of introducing the feedstock into a fluidized bed dryer prior to channeling the feedstock to the gasifier.
